(19) United States
(12) Patent Application Publication
(10) Pub. No.: US 2018/0068506 A1
(43) Pub. Date: Mar. 8, 2018

(54) ENTRY MANAGING SYSTEM

(71) Applicant: JSW Pacific Corporation, New Taipei City (TW)

(72) Inventors: Tsan-Hui LEE, New Taipei City (TW); Chih-Yuan LIN, New Taipei City (TW)

(21) Appl. No.: 15/257,792

(22) Filed: Sep. 6, 2016

(51) Int. Cl. G07C 9/00; H04L 9/32; G06K 9/00; G06K 9/62; G06K 19/06

(52) U.S. Cl. CPC G07C 9/00111; H04L 9/3231; G06K 9/00771; G06K 9/6201; G07C 2009/00095; G07C 9/00087; G06K 19/06028; G07C 9/00103; G06K 19/06037

(57) ABSTRACT

An entry managing system connected to a door-lock device is disclosed. The system controls a camera to start shooting a monitoring video of a monitoring region and stores the monitoring video in a memory when a doorbell trigger receives an operation of a visitor. The system decodes an authentication pattern to extract a visitor data when recognizing the authentication pattern in the monitoring video during shooting. The system controls the door-lock device to unlock when determining that the visitor data passes authentication. Via using the authentication pattern as an electronic key and using the camera to read the authentication pattern, this present disclosed example not only can make it easy that the administrator configures and gives a key, but also can recognize the electronic key without an additional electronic-key-reading device.

### BACKGROUND OF THE INVENTION

### Field of the Invention

The technical field relates to system and more particularly related to entry managing system.

### Description of Related Art

Most of the entry managing means of the related art implement the entry management by using a physical key. Take the entry management of hotel for example, a roomer must retrieve a specific physical key from the administrator of the hotel when checking in, and must return the physical key when checking out.

Above-mentioned means using the physical key have following problems. The administrator needs to stay at the hotel for providing the roomer the physical key and getting the physical key returned by the roomer; because a keyhole structure of a door-lock device is one-by-one corresponded to a key structure, once the physical key is lost, the administrator must replace the whole door-lock device with a new one for security reasons; and sometimes the physical key is too big to carry and keep conveniently.

Besides, an entry managing means using an electronic device had been provided. Above-mentioned entry managing means uses the Radio Frequency Identification (RFID) tag or biological data (such as iris or fingerprint) as the electronic key. Take using the RFID tag for example, the roomer must retrieve the RFID tag from the administrator when checking in, and must return the RFID tag when checking out. Take using the biological data for example, the administrator can retrieve the roomer's biological data and make the roomer's biological data store in the door-lock device in advance such that the roomer can input the roomer's biological data to unlock the door-lock device and enter the room directly without retrieving any physical key.

Above-mentioned entry managing means using the electronic key have following problems. The administrator still needs to stay at the hotel for providing the roomer the RFID tag and getting the RFID tag returned by the roomer in the entry managing means using RFID tag, there is a doubt of data leakage in the entry managing means using the biological data; and, the administrator must additionally install an electronic-key-reading device on the door-lock device (such as RFID reader or fingerprint scanner) in both means. As a result, the cost is increased.

### SUMMARY OF THE INVENTION

The object of this present disclosed example is to provide an entry managing system using an optical electronic key without an additional electronic-key-reading device.

One of the exemplary embodiments, an entry managing system, comprises:

a doorbell trigger receiving an operation and triggering a doorbell signal;

a camera starting to shoot a monitoring video of a monitoring region when the doorbell signal is triggered; and

a processor electrically connected to the doorbell trigger, the camera and an external door-lock device, the processor decoding an authentication pattern to extract a visitor data when recognizing the authentication pattern in the monitoring video during shooting, and controlling the door-lock device to unlock when determining that the visitor data passes authentication.

Via using the authentication pattern as an electronic key and using the camera to read the authentication pattern, this present disclosed example not only can make it easy that the administrator configures and gives a key, but also can recognize the electronic key without an additional electronic-key-reading device.

### BRIEF DESCRIPTION OF DRAWING

The features of this present disclosed example believed to be novel are set forth with particularity in the appended claims. This present disclosed example itself, however, may be best understood by reference to the following detailed description of this present disclosed example, which describes an exemplary embodiment of this present disclosed example, taken in conjunction with the accompanying drawings, in which:

FIG. 1 is an architecture diagram of an entry managing system according to a first embodiment of this present disclosed example;

FIG. 2 is a flowchart of an entry managing method according to a first embodiment of this present disclosed example;

FIG. 3 is an architecture diagram of an entry managing system according to a second embodiment of this present disclosed example;

FIG. 4 is a schematic view of an entry managing system according to the third embodiment of this present disclosed example; and

FIG. 5 is a flowchart of an entry managing method according to a second embodiment of this present disclosed example.

### DETAILED DESCRIPTION OF THE INVENTION

In cooperation with the attached drawings, the technical contents and detailed description of the present invention are described thereinafter according to a preferable embodiment, being not used to limit its executing scope. Any equivalent variation and modification made according to appended claims is all covered by the claims claimed by the present invention.

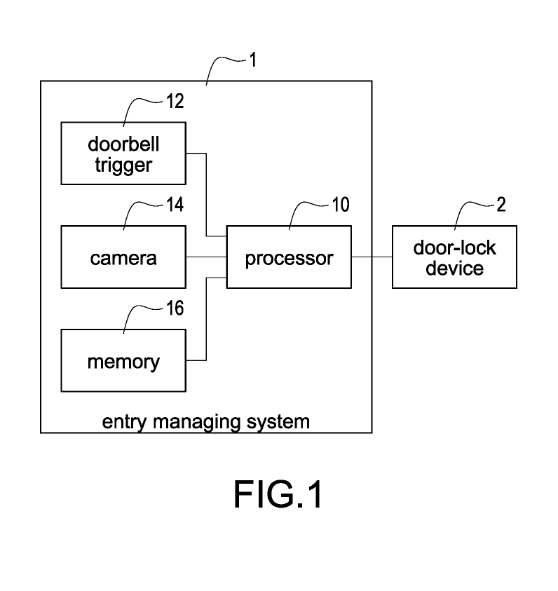

First, please refer to FIG. 1, which illustrates an architecture diagram of an entry managing system according to a first embodiment of this present disclosed example.

As shown in FIG. 1, an entry managing system 1 of this present disclosed example mainly comprises a doorbell trigger 12, a camera 14, a memory 16, and a processor 10 electrically connected to above-mentioned elements.

The doorbell trigger 12 (such as physical button, touch button or proximity sensor) is installed at the entry of a house (such as a location beside a main door), used to receive an operation of a visitor, and trigger a doorbell signal when receiving the operation (such as pressing the button or shadowing the proximity sensor) of the visitor. The camera 14 is a visible light camera (such as monitor, internet protocol camera (IP Cam) or digital video recorder (DVR)), and used to shoot a monitoring region for monitoring and shoot an authentication pattern for authenticating the visitor's identity. The memory 16 is used to store data. The processor 10 is used to control the entry managing system 1 and the elements thereof. Besides, the processor 10 is electrically connected to an external door-lock device 2 and has ability to control the external door-lock device 2 to lock/unlock.

More specifically, the door-lock device 2 is installed in a main door, and wired or wirelessly connected to the processor 10 of the entry managing system 1 and is controlled by the processor 10 for performing lock/unlock.

The entry managing system 1 of this present disclosed example can implement a function of authenticating visitor's identity. More specifically, this present disclosed example uses an authentication pattern to implement an electronic key, and uses the camera 14 to implement an electronic-key-reading device. Furthermore, an administrator can retrieve a registration data (such as the visitor's personal data, the custom word(s) made by the visitor, a room-booking serial number, the authentication codes or any combination of above-mentioned data) of a legitimate visitor in advance, and executes an encoding process to the registration data to generate the authentication pattern by a computer, then provide the generated authentication pattern to the visitor by way of electronic file or paper (such as paper mail, e-mail or communication software).

Thus, the administrator needs not to stay at the hotel for providing the roomer the key and getting the key returned by the roomer. Additionally, after the visitor arrives in a monitoring region of the camera 14, the visitor can produce the authentication pattern such that the camera 14 shoots the produced authentication pattern and make the entry managing system 1 unlock the door-lock device 2 after determining that the visitor's identity passes authentication according to the shot authentication pattern.

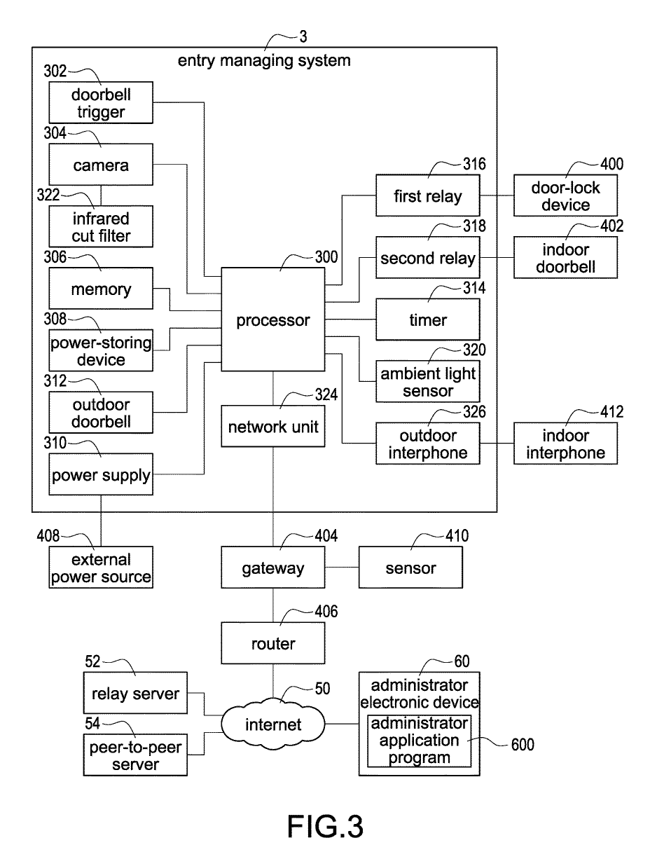

Preferably, the authentication pattern can be a one-dimensional barcode, a two-dimensional barcode (such as QR code) or a pattern embedded a watermark. The administrator can use an electronic device (such as an administrator electronic device 60 shown in FIG. 3) to encode above-mentioned registration data into the one-dimensional barcode or the two-dimensional barcode by a barcode-encoding algorithm, encode above-mentioned registration data into the watermark and embed the watermark in the pattern by a watermark-embedding algorithm, or directly transform the above-mentioned registration data into an image (in other words, save the text-type registration data as the pattern-type registration data).

Via using the authentication pattern as the electronic key, this present disclosed example can not only reduce the cost of manufacturing and assigning, but also provide the visitor more convenience in carrying and keeping the generated electronic key.

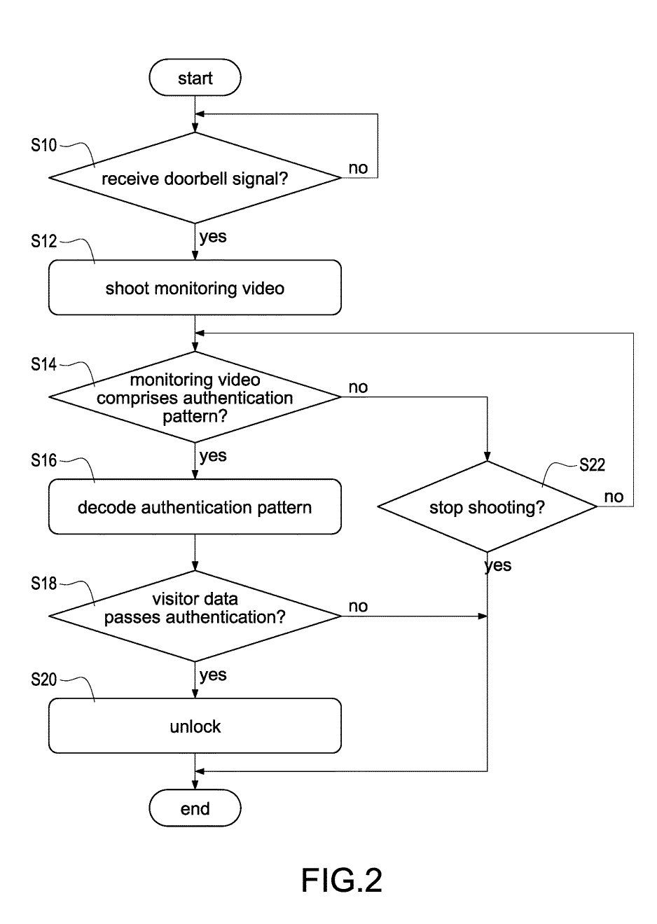

Please also refer to FIG. 2, which illustrates a flowchart of an entry managing method according to a first embodiment of this present disclosed example. The entry managing system 1 of this embodiment implements above-mentioned function of authenticating visitor's identity via performing those steps shown in FIG. 2. Besides, in this embodiment, the entry managing system 1 is installed at a house's entry, starts to shoot the monitoring region and implements the above-mentioned function of authenticating visitor's identity after the visitor arrives in the monitoring region and presses the doorbell trigger 12 (in other words, the doorbell trigger 12 send the doorbell signal).

Although the entry managing system 1 simultaneously shoots the monitoring region and implements above-mentioned function of authenticating visitor's identity after the visitor arrives in a monitoring region and presses the doorbell trigger 12 in this embodiment, this specific example is not intended to limit the scope of this present disclosed example.

In another embodiment of this present disclosed example, the entry managing system 1 always shoots the monitoring region, and implements above-mentioned function of authenticating visitor's identity only after the doorbell trigger 12 is pressed.

Compared to the entry managing means of the related art (the camera is only used to monitor and has no additional function), this present disclosed example can efficiently fully use the camera via above-mentioned means which uses the camera to shoot the authentication pattern.

Step: S10: the processor 10 detects whether a doorbell signal is received from the doorbell trigger 12. If the processor 10 determines that the doorbell signal is received (means that a visitor arrives in the monitoring region and presses the doorbell trigger 12), preforms a step S12. Otherwise, the processor 10 performs the step S10 again for continually detecting whether the doorbell trigger 12 is triggered.

Step: S12: the processor 10 controls the camera 14 to start to shoot a monitoring region, record a monitoring video, and store the monitoring video in the memory 16.

Preferably, the memory 16 is a cache memory, Random Access Memory (RAM) or buffer. The camera 14 real-time stores the shot video in the memory 16 (such as real-time storing the monitoring video in the memory 16 by streaming).

Step: S14: the processor 10 executes a process of recognizing an authentication pattern to the monitoring video real-time for recognizing whether the monitoring video comprises the authentication pattern (means that whether the camera 14 has shot the authentication pattern) during shooting the monitoring video. More specifically, the visitor can make the authentication pattern provided by the administrator face to the camera 14 such that the camera 14 shoots the authentication pattern and make the processor execute authentication of the visitor's identity after pressing the doorbell trigger 12.

Preferably, the processor 10 executes a process of recognizing the authentication pattern to the current shot picture. More specifically, the camera 14 keeps storing the shot video in the memory 16 temporarily. At the same time, the processor 10 continually executes the process of recognizing the authentication pattern to the newest temporarily stored video. Thus, the processor 10 can recognize whether the camera 14 shoots the authentication pattern real-time.

If the processor 10 recognizes the authentication pattern in the monitoring video, performs a step S16. Otherwise, the process 10 performs a step S22.

Step: S16: the processor 10 decodes the recognized authentication pattern to extract a visitor data. Preferably, the processor 10 can determine the type of the authentication pattern according to its sole discretion or a configuration pre-set by the administrator, and extract the visitor data by a specific decoding means corresponding to the determined type.

For example, if the processor 10 determines that the authentication pattern is the one-dimensional barcode or the two-dimensional barcode, the processor 10 can extract the visitor data by a barcode-decoding algorithm; if the processor 10 determines that the authentication pattern is the pattern embedded the watermark, the processor 10 can extract the embedded visitor data by a watermark-extracting algorithm corresponding to the watermark-embedding algorithm; if the processor 10 determines that the authentication pattern is the graphical text, the processor can recognize the text-type visitor data in the authentication pattern by an Optical Character Recognition (OCR) algorithm. Then, the processor 10 performs a step S18.

Step: S18: the processor 10 determines whether the extracted visitor data passes authentication. Preferably, the administrator can pre-store at least one registration data in the memory 16, wherein above-mentioned registration data corresponds to the legitimate visitor and is used to generate the authentication pattern. The processor 10 compares the extracted visitor data with each of the pre-stored registration data individually, and determines that the visitor data passes authentication when determining that any one of the pre-stored registration data is consistent with the extracted visitor data.

If the processor 10 determines that the visitor data passes authentication, determines that the current is the legitimate visitor, and performs the step S20. Otherwise, the processor 10 terminates the entry managing method.

Step: S20: the processor 10 controls the door-lock device 2 to unlock.

If the processor 10 didn't find the authentication pattern in the monitoring video in the step S14, performs a step S22: the processor 10 determining that whether the camera 14 stops shooting. Preferably, the processor 10 controls the camera 14 to stop shooting after controlling the camera 14 to shoot continually for a default monitoring time or detecting that the visitor had left the monitoring region.

If the processor 10 determines that the camera 14 still needs to shoot continually (such as the monitoring time doesn't elapse, or the visitor doesn't leave the monitoring region), performs the step S14 again so as to continually detect whether the monitoring video comprises the authentication pattern. If the processor determines that the camera 14 could stop shooting (such as the monitoring time elapsed, or the visitor left the monitoring region), terminates the entry managing method.

Via using the authentication pattern as an electronic key and using the camera to read the authentication pattern, this present disclosed example can facilitate the administrator to configure and give a key. Moreover, the electronic key can be recognized without an additional electronic-key-reading device.

Besides, when the visitor loses or leaks the visitor's the authentication pattern, the administrator only need to update the registration data corresponding to the visitor, generate a new authentication pattern according to the new registration data and provide the new authentication pattern to the visitor to complete the tasks of re-manufacturing and re-assigning the key without replacing the door-lock device.

Please refer to FIG. 3, which illustrates an architecture diagram of an entry managing system according to a second embodiment of this present disclosed example. The processor 300, the doorbell trigger 302, the camera 304, the memory 306 and the door-lock device 400 of the entry managing system 3 shown in FIG. 3 correspond to the processor 10, the doorbell trigger 12, the camera 14, the memory 16 and the door-lock device 2 of the entry managing system 1 shown in FIG. 1, the relevant description is omitted for brevity.

In this embodiment, the entry managing system 3 comprises a power-storing device 308 (such as battery). The power-storing device 308 is electrically connected to the processor 300, used to store power and provide the power required by the entry managing system 3 for the operating.

In another embodiment of this present disclosed example, the entry managing system 3 further comprises a power supply 310. The power supply 310 is electrically connected to the processor 300 and an external power source 408 (such as mains power), the power supply 310 can retrieve the power and transfer it to the processor 300 for providing the power required by the entry managing system 3 for the operating.

In another embodiment of this present disclosed example, the entry managing system 3 comprises both the power-storing device 308 and the power supply 310. In the general status, the entry managing system 3 selects the power supply 310 as the power source. When power supply of the power supply 310 is interrupted, the entry managing system 3 can automatically select the power-storing device 308 as the power source for continual operation. This present disclosed example can make the entry managing system 4 keep operating when the external power source 408 is interrupted via providing power redundancy.

In another embodiment of this present disclosed example, the entry managing system 3 further comprises an outdoor doorbell 312 electrically connected to the processor 300. The outdoor doorbell 312 rings when every time the doorbell signal is triggered, or rings only when the processor 300 determines that the visitor data does not pass authentication.

In another embodiment of this present disclosed example, the entry managing system 3 further comprises a timer 314 electrically connected to the processor 300. The timer 314 can time a default monitoring time (such as 3 minutes) when the camera 314 starts to shoot, and notify the processor 300 or the camera 304 when the monitoring time elapses such that the camera 304 automatically stops shooting. This present disclosed example can effectively control the data volume of the monitoring data, and prevent from wasting the storage space of the memory 306 (in other words, preventing the camera 304 from still continually shooting after the visitor had left the monitoring region for a long time) via fixing the shoot time.

In another embodiment of this present disclosed example, the entry managing system 3 further comprises a plurality of relays electrically connected to the processor 300. The relays can be respectively electrically connected to the different external devices, and the processor 300 can respectively control each external device via each relay 300. More specifically, the processor 300 can use a signal of small current to control the external devices of high current driving via the installation of the relays.

For example, as shown in FIG. 3, the entry managing system 3 comprises a first relay 316 and a second relay 318. The first relay316 is connected to the door-lock device 400 (which is the external device) installed in the main door. The second relay 318 is connected to an indoor doorbell 402 (which is the external device) installed inside the house.

Via connecting to the door-lock device 400 through the first relay 316, the processor 300 can control the door-lock device 400 to unlock/lock by sending an unlock/lock signal of small current to the first relay 316.

Via connecting to the door-lock device 400 through the first relay 316, the processor 300 can simultaneously control the outdoor doorbell 312 and the indoor doorbell 402 to ring when the doorbell trigger 302 is triggered or determining that the visitor data passes authentication. Thus, the visitor outside the house and the household inside the house can clearly and simultaneously hear the ring.

In another embodiment of this present disclosed example, the entry managing system 3 further comprises an ambient light sensor 320. The ambient light sensor 320 is electrically connected to the processor 300, and has ability to sense an illumination of the monitoring region.

In this embodiment, the camera 304 further comprises two shooting modes, namely, a color mode and a gray-scale mode. The camera 304 can generate the color monitoring video in the color mode, and generate the gray-scale monitoring video in the gray-scale mode.

Furthermore, the processor 300 can control the camera 304 switches to the color mode when determining that the illumination sensed by the ambient light sensor 320 is not less than a default illumination configured by the administrator, and control the camera 304 switches to the gray-scale mode when determining that the illumination is less than the default illumination.

Please be noted that the video shot by the camera 304 is unable to reflect the real object's colors when the illumination is insufficient. Moreover, the incorrect object's colors could make the following process (such as recognizing the authentication pattern) fault. Thus, this present disclosed example can effectively prevent the incorrect object's colors from making the recognition fault via automatically switching to the gray-scale mode and shooting when the illumination is insufficient.

In another embodiment of this present disclosed example, the entry managing system 3 further comprises an infrared (IR) cut filter 322. The infrared cut filter 322 is installed in a light path of the camera 304 such that the ambient light must first pass through the infrared cut filter 322 before reaching an image sensor. More specifically, the infrared cut filter 322 can filter the infrared in the light path so as to make the ambient infrared unable to irradiate the image sensor of the camera 304 when the infrared cut filter 322 is enabled; the infrared cut filter 322 can stop filtering the infrared in the light path such that make the ambient infrared irradiates the image sensor of the camera 304 when infrared cut filter 322 is disabled or removed. Preferably, the infrared cut filter 322 is an infrared cut filter removable (ICR). The processor 300 or the camera 304 controls the infrared cut filter 322 to enable or disable by electronic means.

Preferably, the processor 300 enables the infrared cut filter 322 for filtering the infrared when the illumination is not less than the default illumination, and disables the infrared cut filter 322 for stopping filtering the infrared and controls the camera 304 to switch to the gray-scale mode when the illumination is less than the default illumination.

Furthermore, the entry managing system 3 further comprises an infrared lamp (not shown in the figures). The infrared lamp is electrically connected to the processor 300 and used to provide better infrared illumination. The processor 300 controls the infrared lamp to turn on for providing invisible light illumination when the illumination is less than the default illumination, and controls the infrared lamp to turn off for saving power when the illumination is not less than the default illumination.

Thus, this present disclosed example can effectively prevent the object's colors or brightness in the monitoring video from being incorrect caused by infrared interference when the luminance is sufficient. This present disclosed example can effectively increase the brightness of the objects in the monitoring video (the infrared has ability of illuminating the monitoring region because it has light energy) so as to reduce the difficulty of recognition when the luminance is insufficient.

In another embodiment of this present disclosed example, the entry managing system 3 further comprises a network unit 324, such as Bluetooth device, Wi-Fi device, Ethernet device or mobile network (the cellular network, such as Long Term Evolution (LTE)) device. The network unit 324 is electrically connected to the processor 300, and connected to the internet 50. Preferably, the network unit 324 is connected to the internet 50 by a gateway 404 and a router 406.

In another embodiment of this present disclosed example, the entry managing system 3 further comprises an administrator application program 600. The administrator application program 600 is installed in an external administrator electronic device 60 (such as smart phone, tablet, laptop, wearable device or personal computer), and can control the administrator electronic device 60 to execute following operation related to the administrator electronic device 60. The administrator electronic device 60 is connected to the internet 50, and held by the administrator.

Preferably, the administrator electronic device 60 can establish a peer-to-peer (P2P) connection with the network unit 324 of the entry managing system 3. More specifically, the network unit 324 can periodically (such as every 12 hours, or every time the network address changing) transfer a current network address (such as internet protocol (IP) address) of the network unit 324 to a peer-to-peer server 54 via the internet 50. The administrator electronic device 60 can retrieve the newest network address of the network unit 324 from the peer-to-peer server 54 via the internet 50, and establish the peer-to-peer connection with the network unit 324 according to the retrieved network address of the network unit 324.

Furthermore, after the connection is established, the administrator can remotely control each element of the entry managing system 3 by operating the administrator electronic device 60, such as watching the video shot by the camera 304, controlling any element to turn on/off, or configuring the parameters of the entry managing system 3.

Thus, even the network unit 324 uses the dynamic IP address, this present disclosed example can make the administrator electronic device 60 located remotely execute the peer-to-peer communication with the entry managing system 3.

In another embodiment of this present disclosed example, the network unit 324 communicates with the entry managing system 3 by relay transmission service (such as Google Cloud Messaging (GCM) or Apple Push Notification Service (APNs)) rather than the peer-to-peer connection. More specifically, above-mentioned relay transmission service is to provide a relay server 52 which has a fixed network address. The relay server 52 can receive data from the administrator electronic device 60 and forward the received data to the network unit 324, or receive data from the network unit 324 and forward the received data to the administrator electronic device 60.

For example, the processor 300 can generate an authentication result after authenticating the visitor data, and transfer the authentication result to the relay server 52. Then, the relay server 52 forwards the authentication result to the administrator electronic device 60 for displaying.

Thus, even the network unit 324 and the administrator electronic device 60 don't know the network addresses of each other, they can still communicate with each other.

Furthermore, the network unit 324 can further transfer the visitor data to the administrator electronic device 60 via the relay server 52. Besides, the administrator application program 600 can compare the visitor data with each of a plurality of the contacts data. If the visitor data is consistent with any contacts data, the administrator application program 600 fetches a specific field (such as photo or name) of this consistent contacts data, and displays the specific field on a display of the administrator electronic device 60.

This present disclosed example can make the administrator easily understand the identity of the visitor via transforming the visitor data into the contacts data.

In another embodiment of this present disclosed example, the entry managing system 3 further comprises an outdoor interphone 326. The outdoor interphone 326 is electrically connected to the processor 300, and used to receive and play audio. More specifically, the outdoor interphone 326 is further connected to an indoor interphone 412 installed inside the house. The outdoor interphone 326 can receive a visitor audio data and transfer the visitor audio data to indoor interphone 412 for playback, or play an administrator audio data received from the indoor interphone 412.

Thus, the visitor can make a conversation with the household inside the house by the outdoor interphone 326.

In another embodiment of this present disclosed example, the processor 300 can transfer above-mentioned visitor audio data to the administrator electronic device 60 for playback via the network unit 324. At the same time, the administrator electronic device 60 can receive the administrator audio data of the administrator via a built-in microphone, and transfer the administrator audio data (through the peer-to-peer connection or the relay server 52) to the outdoor interphone 326 of the entry managing system 3 for playback. Thus, even the administrator is not inside the house, the visitor can still make a real-time remote audio communication with the administrator located remotely.

In another embodiment of this present disclosed example, the gateway 404 further connects to at least one sensor 410 (for example, a human detector (such as Passive infrared sensor (PIR) sensor, thermal image sensor or ultrasonic sensor) a luminance measuring meter or magnetic door sensor). The processor 300 of the entry managing system 3 can receive the data of the sensor 410 via the gateway 404, and execute the corresponded process or operation.

Taking human detector or magnetic door sensor for the example of the sensor 410, the sensor 410 can trigger a sensing signal when detecting that the visitor enters the monitoring region or the door magnet is blocked (such as the main door being opened), the processor 300 can control the camera 304 to shoot when receiving above-mentioned sensing signal.

Taking luminance measuring meter for the example of the sensor 410, the sensor 410 can measure the illuminance of a monitoring environment, the processor 300 can control the camera 300 to switch mode between the color mode and the gray-scale mode, or control the infrared cut filter 322 to enable or disable according to the illuminance sensed by the sensor 410.

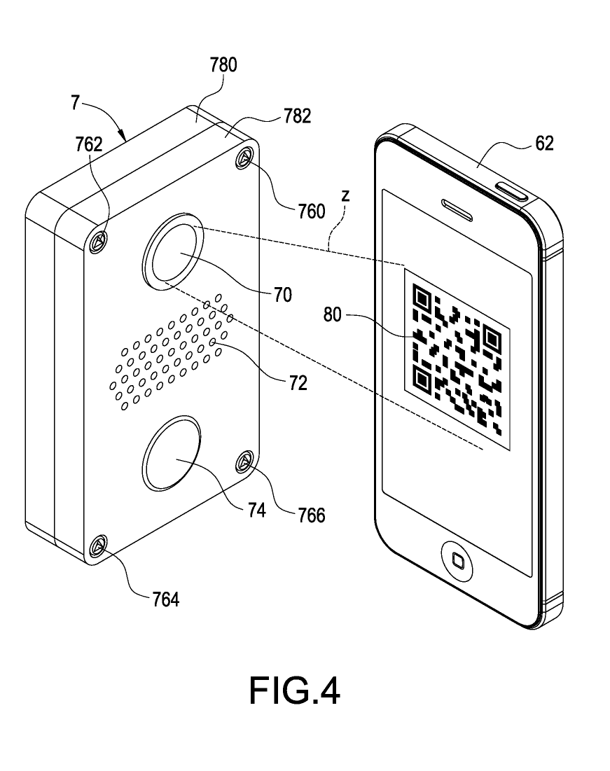

Please refer to FIG. 4, which illustrates a schematic view of an entry managing system according to the third embodiment of this present disclosed example. The entry managing system 7, the camera 70, the outdoor doorbell 72 and the doorbell trigger 74 of this embodiment correspond to the entry managing system 3, the camera 304, the outdoor doorbell 312 and the doorbell trigger 302 shown in FIG. 3, and the relevant description is omitted for brevity. In this embodiment, the entry managing system 7 is installed at the entry of a house. Besides, the camera is used to shoot the position which the main door located (in other words, a monitor zone Z comprises the main door and around).

In this embodiment, after the visitor arrival the entry, the visitor can operate the visitor's visitor electronic device 62 (take smart phone for example) to display an authentication pattern 80 (take QR code for example), and move the visitor electronic device 62 to inside the monitor zone Z of the camera 70 for authenticating the visitor's identity after pressing the doorbell trigger 74.

Besides, in this embodiment, the entry managing system 7 further comprises a first case 780 and a second case 7821. The first case 780 is fixedly connected with the second case 782 by at least one anti-theft screw (take the anti-theft screw 760-766 for example). The fixedly connected first case 780 and second case 782 can partially cover or completely cover each elements of the entry managing system 7 for providing protection.

Preferably, because above-mentioned anti-theft screw comprises a lock-hole having peculiar shape (such as triangle or irregular), above-mentioned anti-theft screw is unable to drive by using a general screwdriver so as to effectively prevent the entry managing system 7 from destruction or demolition.

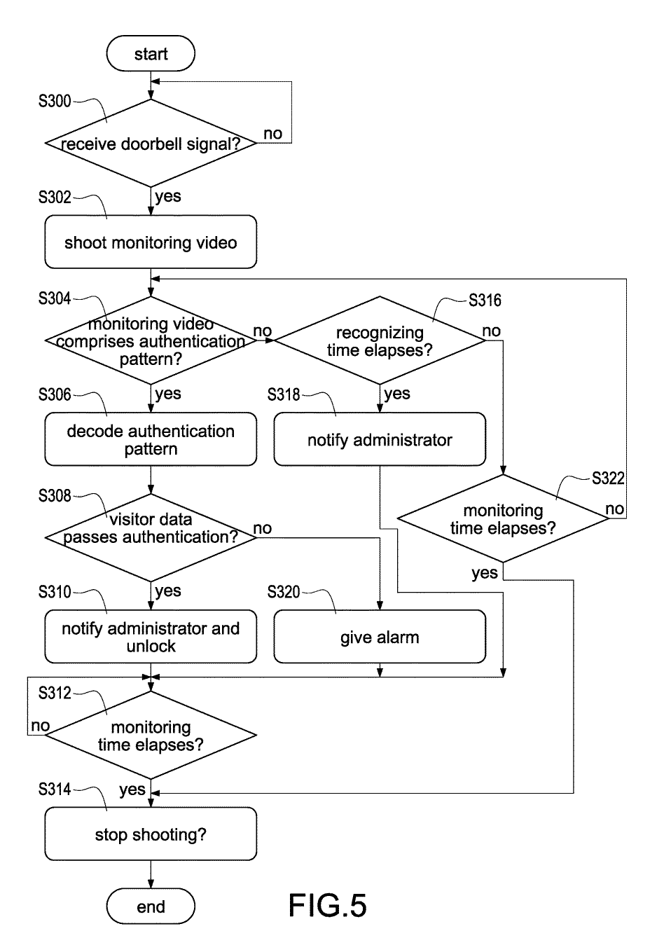

Please refer to FIG. 5, which illustrates a flowchart of an entry managing method according to a second embodiment of this present disclosed example. The entry managing method in this embodiment is mainly implemented by the entry managing system 3 as illustrated in FIG. 3. Besides, in this embodiment, the entry managing system 3 is installed at the entry of a house, the administrator holds the administrator electronic device 60 and is located remotely (also can be inside the house). Besides, the entry managing system 3 can control the camera 304 continually shoot for the default monitoring time (such as 60 seconds) when every time the doorbell signal is triggered, wherein above-mentioned default monitoring time is configured by the administrator (or configured in the manufacturing factory of the entry managing system 3).

Preferably, the entry managing system 3 transfers/receives message or data to/from the administrator electronic device 60 by relay transmission service (such as GCM or APNs). The entry managing system of this embodiment comprises following steps.

The step S300, S302 are similar to the step S10, S12 shown in FIG. 2 respectively, the relevant description is omitted for brevity.

Step: S304: the processor 300 real-time executes a process of recognizing an authentication pattern to the in-shooting monitoring video so as to recognize whether the shot picture comprises the authentication pattern (in other words, determining whether the camera 14 had shot the authentication pattern) during shooting the monitoring video.

If the processor 300 recognizes the authentication pattern in the monitoring video, performs a step S306. Otherwise, the processor 300 performs a step S316.

Step: S306: the processor 300 decodes the recognized authentication pattern for extracting a visitor data.

Step: S308: the processor 300 determines whether the extracted visitor data passes authentication. If the processor 300 determines that the extracted visitor data passes authentication, determines that the current visitor is a legitimate visitor and performs the step S310. Otherwise, the processor 300 performs a step S320.

Step: S310: the processor 300 sends a legitimate visitor notification message to the administrator electronic device 60 so as to notify the administrator that the current visitor had passed authentication and the door-lock device 400 will be unlock later. Then, the processor 300 controls the door-lock device 400 to unlock via the first relay 316.

Preferably, above-mentioned legitimate visitor notification message can comprise all or part of the visitor data which is extracted from the authentication pattern.

In another embodiment of this present disclosed example, the processor 300 doesn't automatically control the door-lock device 40 to unlock, the processor 300 controls the door-lock device 400 to unlock when receiving unlock confirmation message from the administrator electronic device 60. More specifically, the administrator can operate the administrator electronic device 60 to return above-mentioned unlock confirmation message to the administrator electronic device 60 for instructing the processor to execute an unlock control after reading the legitimate visitor notification message.

Step: S312: the processor 300 determines whether the monitoring time elapses. More specifically, the processor 300 times the default monitoring time and determines whether the monitoring time elapses via the timer 314 after starting to shoot the monitoring video (step S302).

If the processor 300 determines that the monitoring time elapses, performs the step S314. Otherwise, the processor 300 performs the step S312 again.

Step: S314: the processor 300 controls the camera 304 to stop shooting. Furthermore, the processor 300 can store the monitoring video shot this time in the memory 306 by a form of video file (such as MP4 file format, MKV file format or AVI file format).

If the processor 300 is unable to recognize any authentication pattern in the step S304, performs the step S316: the processor determining whether a recognizing time elapses. More specifically, after starting to shoot the monitoring video (step S302), the processor 300 times the recognizing time (such as 5 seconds), and determines whether the recognizing time elapses, wherein above-mentioned recognizing time is not greater than above-mentioned monitoring time.

Preferably, above-mentioned recognizing time is configured by the administrator (or configured in the manufacturing factory of the entry managing system 3). Besides, the processor 300 recognizes whether the monitoring video comprises the authentication pattern only in the default time interval (such as the time interval after starting to shoot the monitoring video before the recognizing time elapses). In other words, the processor 300 will not recognize whether the monitoring video comprises the authentication pattern and only control the camera 304 to shoot the monitoring video after the recognizing time elapses.

Because the time interval of allowing to recognize the authentication pattern is very short in this present disclosed example, this present disclosed example can effectively prevent the illegal visitor from cracking authentication by brute-force attack (means that trying to pass authentication via continually replacing the different authentication pattern)

If the processor 300 determines that the recognizing time elapses, performs the step S318. Otherwise, the process 300 performs the step S322.

Step: S318: the processor 300 sends an authentication-pattern not found notification message to the administrator electronic device 60 via the network unit 324 for notifying the administrator that the current visitor didn't show any authentication pattern.

Preferably, the processor 300 can further transfer a current shot picture to the administrator electronic device 60 by means of screenshot or streaming such that the administrator knows the appearance of the current visitor real-time.

Then, the processor 300 performs a step S312.

If the processor 300 determines that the extracted visitor data does not pass authentication in the step S308, performs the step S320: the processor sending an illegal visitor notification message to the administrator electronic device 60 via the network unit 324 so as to alert the administrator that there is the illegal visitor at the entry of the house. Thus, this present disclosed example can make the administrator make a response (such as calling the police or deterring the illegal visitor via the outdoor interphone 326) to the illegal visitor real-time.

Preferably, the processor 300 can further control the outdoor doorbell 312 and the indoor doorbell 402 to ring, or control the outdoor interphone 326 and the indoor interphone 412 to play a default alert audio so as to attract the notice of people nearby (such as household inside the house or passers outside the house) for deterring the behavior of destruction or theft.

Preferably, above-mentioned illegal visitor notification message can comprise all or part of the visitor data which does not pass authentication (the visitor data is extracted from the authentication pattern).

Preferably, the processor 300 can further add the current shot picture of the camera 304 to above-mentioned illegal visitor notification message by means of screenshot and send it. Or, the processor 300 can transfer the current shot picture to the administrator electronic device 60 by means of streaming. Thus, the administrator can know the appearance of the current illegal visitor real-time.

Then, the processor 300 performs the step S312.

If the processor 300 determines that the recognizing time doesn't elapse in the step S316, performs the step S322: the processor 300 determining whether above-mentioned monitoring time elapses. If the processor 300 determines that the monitoring time elapses, performs the step S314. Otherwise, the processor 300 performs the step S304 again.

The above mentioned are only preferred specific examples in this present disclosed example, and are not thence restrictive to the scope of claims of this present disclosed example. Therefore, those who apply equivalent changes incorporating contents from this present disclosed example are included in the scope of this application, as stated herein.

What is claimed is:

1. An entry managing system, comprising:
a doorbell trigger receiving an operation and triggering a doorbell signal;
a camera starting to shoot a monitoring video of a monitoring region when the doorbell signal is triggered; and
a processor electrically connected to the doorbell trigger, the camera and an external door-lock device, the processor decoding an authentication pattern to extract a visitor data when recognizing the authentication pattern in the monitoring video during shooting, and controlling the door-lock device to unlock when determining that the visitor data passes authentication.

2. The entry managing system according to claim 1, wherein the entry managing system further comprises a memory electrically connected to the processor, the memory stores at least one registration data, the processor determines that the visitor data passes authentication when determining that any registration data is consistent with the visitor data.

3. The entry managing system according to claim 1, wherein the entry managing system further comprises an outdoor doorbell electrically connected to the processor, the outdoor doorbell rings when the visitor data does not pass authentication.

4. The entry managing system according to claim 1, wherein the entry managing system further comprises a timer electrically connected to the processor, the timer times a monitoring time after the camera starts to shoot, the camera stops shooting after the monitoring time elapses.

5. The entry managing system according to claim 1, wherein the entry managing system further comprises an ambient light sensor electrically connected to the processor, the ambient light sensor senses an illumination of the monitoring region.

6. The entry managing system according to claim 5, wherein the camera switches to a color mode for generating the color monitoring video when the illumination is not less than a default illumination, and switches to a gray-scale mode for generating the gray-scale monitoring video when the illumination is less than the default illumination.

7. The entry managing system according to claim 6, wherein the entry managing system further comprises an infrared cut filter installed in a light path of the camera, the infrared cut filter enables for filtering the infrared in the light path when the illumination is not less than the default illumination, and disables for stopping filtering the infrared in the light path when the illumination is less than the default illumination.

8. The entry managing system according to claim 1, wherein the entry managing system further comprises a first case and a second case, the first case is fixedly connected with the second case by at least one anti-theft screw, the fixedly connected first case and second case cover the camera and the processor.

9. The entry managing system according to claim 1, wherein the entry managing system further comprises:
a first relay electrically connected to the processor and the door-lock device, using to control the door-lock device to unlock; and
a second relay electrically connected to the processor and an indoor doorbell, using to enable the indoor doorbell for ringing when the visitor data does not pass authentication.

10. The entry managing system according to claim 1, wherein the entry managing system further comprises:
an outdoor interphone electrically connected to the processor, receiving a visitor audio data and playing an administrator audio data; and
a network unit electrically connected to the processor, transferring the visitor audio data to an administrator electronic device via the internet, and receiving the administrator audio data from the administrator electronic device.

11. The entry managing system according to claim 1, wherein the authentication pattern is a two-dimensional barcode.

12. The entry managing system according to claim 1, wherein the entry managing system further comprises:
a network unit electrically connected to the processor, transferring an authentication result of the visitor data to a relay server via the internet; and
an administrator application program installed in an external administrator electronic device, controlling the administrator electronic device to receive the authentication result from the relay server, and displaying the authentication result.

13. The entry managing system according to claim 1, wherein the entry managing system further comprises:
a network unit electrically connected to the processor, periodically transferring a current network address of the network unit to a peer-to-peer server via the internet; and
an administrator application program installed in an external administrator electronic device, controlling the administrator electronic device to retrieve the network address of the network unit from the peer-to-peer server, establishing a peer-to-peer connection with the network unit, and remotely controlling the entry managing system via the peer-to-peer connection.
